(19) United States
(12) Patent Application Publication
(10) Pub. No.: US 2009/0055230 A1
(43) Pub. Date: Feb. 26, 2009

(54) Process for validating and proving technical marketing and competitive analysis from hands-on lab testing and publicly available research information

(76) Inventor: Craig Thomas Ellrod, Santa Clara, CA (US)

Correspondence Address: Craig Thomas Ellrod, 2250 Monroe Street, # 305, Santa Clara, CA, 95050, US

(21) Appl. No.: 11/894,823

(22) Filed: Aug. 22, 2007

(51) Int. Cl. G06Q 10/00

(52) U.S. Cl. 705/7

(57) ABSTRACT

A process for validating and proving competitive analysis from hands-on lab testing and publicly available research information with the steps of: Gathering publicly available information, Compiling information gathered from Research, Preparing Lab Layout in a network diagram, Developing test methodology and test plans, Building physical test network, Placing device under test, or device to be tested into the test network, Performing the test, Examing the results of testing, Determining if results of testing are compatible with gathered Research, Revising test methodology and test plan, and re-testing the device, Compiling information gathered from hands-on validation lab testing, Combining data from Research phase and Validation testing phase, Performing technical marketing and competitive analysis on Research and Validation testing data, Presenting findings of technical marketing and competitive analysis in output.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of Technical Marketing and more specifically to a process for validating and proving competitive analysis from hands-on lab testing and publicly available research information.

### BRIEF SUMMARY OF THE INVENTION

The primary object of the invention is To provide a method for generating high quality, fast and accurate technical marketing and competitive analysis data.

Another object of the invention is To provide a method for combining a Research Phase, a Validation Testing Phase, with a Competitive Analysis Phase and providing output in a Presentation Phase.

Another object of the invention is To provide a method for generating highly focused, targeted data for use in determining a company's strategic direction and product direction.

A further object of the invention is To provide a method for generating data for strategic direction and market postioning.

Yet another object of the invention is To provide a method for generating data for determining intellectual property direction.

Still yet another object of the invention is To provide a method for generating data to reduct costs, increase profitability, and reduce the time to market.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a process for validating and proving competitive analysis from hands-on lab testing and publicly available research information, comprising the steps of: Gathering publicly available information from the internet, Gathering publicly available information from tradeshows, Gathering publicly available information from published financials, Gathering Information from insiders, Gathering Information from industry analysts, Gathering Information from industry press, Compiling information gathered from Research, Preparing Lab Layout in a network diagram electronically with computer software or manually on paper or whiteboard, Developing test methodology and test plan electronically with computer software or manually on paper or whiteboard, Building physical test network, Placing device under test, or device to be tested into the test network, Performing the test, Examing the results of testing, Determining if results of testing are compatible with gathered Research, Revising test methodology and test plan, and re-testing the device, Compiling information gathered from hands-on validation lab testing, Combining data from Research phase and Validation testing phase, Performing technical marketing and competitive analysis on Research and Validation testing data, Presenting findings of technical marketing and competitive analysis in output, Presenting findings of technical marketing and competitive analysis in Technical Briefs, Presenting findings of technical marketing and competitive analysis in Technical Alerts, Presenting findings of technical marketing and competitive analysis in Technical Presentations, Presenting findings of technical marketing and competitive analysis in Sales Presentations, Presenting findings of technical marketing and competitive analysis in Sales Training, Presenting findings of technical marketing and competitive analysis in Sales Webinars, Presenting findings of technical marketing and competitive analysis in Training documents, Presenting findings of technical marketing and competitive analysis in Training presentations, Presenting findings of technical marketing and competitive analysis in Transfer of Information, Presenting findings of technical marketing and competitive analysis in How-to Guides, Presenting findings of technical marketing and competitive analysis in Implementation Guides, Presenting findings of technical marketing and competitive analysis in White Papers, Presenting findings of technical marketing and competitive analysis in Website Collateral, Presenting findings of technical marketing and competitive analysis in Press Releases, Presenting findings of technical marketing and competitive analysis in Presentation kits, Presenting findings of technical marketing and competitive analysis in Marketing Kits, Presenting findings of technical marketing and competitive analysis in Competitive Reports, Presenting findings of technical marketing and competitive analysis in Analyst Reports, Presenting findings of technical marketing and competitive analysis in Industry Reports, Presenting findings of technical marketing and competitive analysis in Product Datasheets, Presenting findings of technical marketing and competitive analysis in RFI, RFQ RFP responses, Presenting findings of technical marketing and competitive analysis in RFI, RFQ, RFP boilerplates, Presenting findings of technical marketing and competitive analysis in MRD's, Presenting findings of technical marketing and competitive analysis in PRD's, Presenting findings of technical marketing and competitive analysis in Proof of Record, Presenting findings of technical marketing and competitive analysis in Roadmaps, Presenting findings of technical marketing and competitive analysis in Intellectual Property documents, Presenting findings of technical marketing and competitive analysis in Strategic planning, Presenting findings of technical marketing and competitive analysis in Product Management documents, Presenting findings of technical marketing and competitive analysis in Product Marketing documents, and Presenting findings of technical marketing and competitive analysis in Competitive Marketing documents.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. <1a> is a flow chart of the operations that comprise the method in the Research phase.

FIG. <1b> is a flow chart of the operations that comprise the method in the Validation Testing phase.

FIG. <1c> is a flow chart of the operations that comprise the method in the Competitive Analysis phase.

FIG. <1d> is a flow chart of the operations that comprise the method in the Presentation phase.

### DETAILED DESCRIPTION OF THE PREFERRED EMBODIMENTS

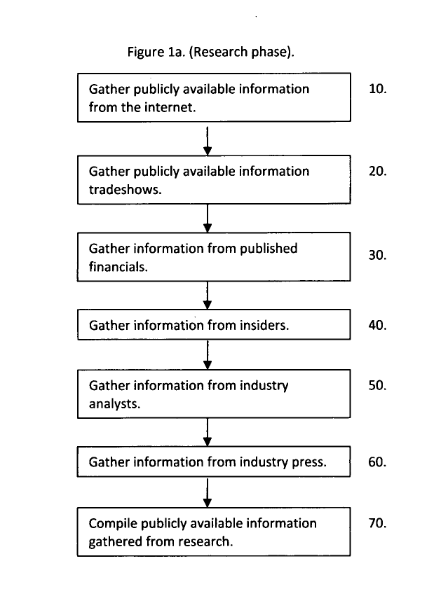

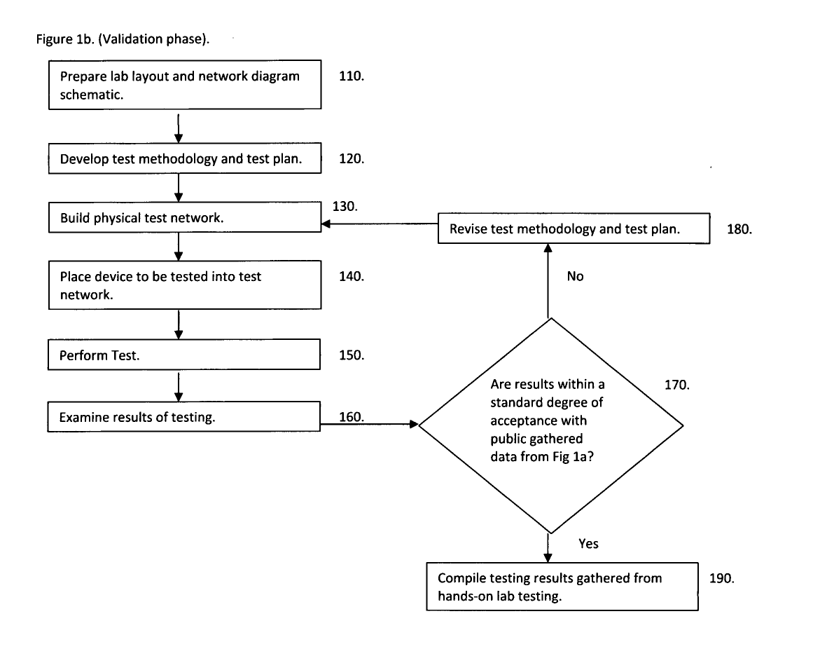

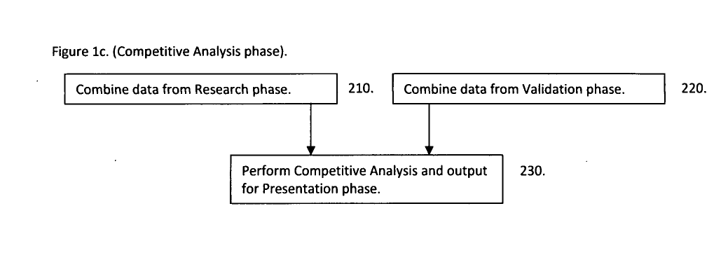

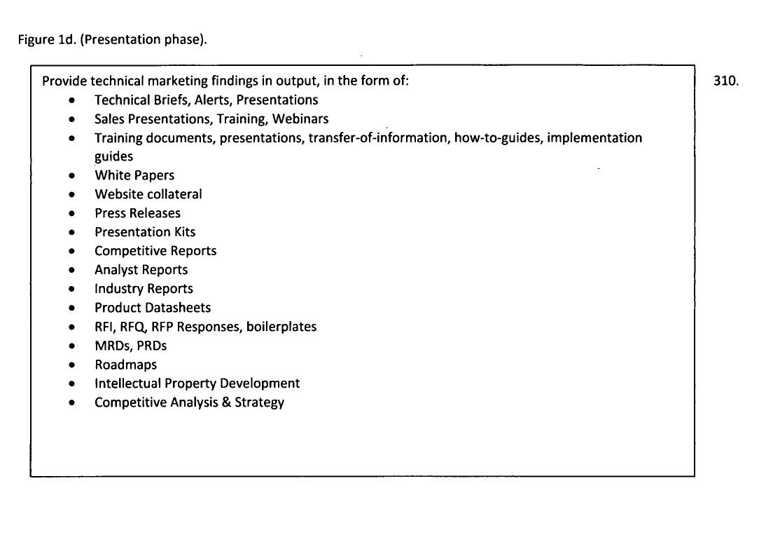

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner. In accordance with the present invention, FIG. 1a shows the process for the Research phase, comprising the steps of gathering publicly available information from the internet (10), gathering publicly available information from tradeshows (20), gathering publicly available information from published financials (30), gathering information from company insiders (40), gathering information from industry analysts (50), gathering information from industry press (60), compiling information gathered through research (70).

In accordance with the present invention, FIG. 1b shows the process for the Validation phase, comprising the steps of Preparing Lab Layout in a network diagram electronically with computer software or manually on paper or whiteboard (110), Developing test methodology and test plan electronically with computer software or manually on paper or whiteboard (120), Building physical test network (130), Placing device under test or device to be tested into the test network (140), Performing the test (150), Examing the results of testing (160), Determining if results of testing are compatible with gathered Research (170), Revising test methodology and test plan (180), and re-testing the device (130), finally Compiling information gathered from hands-on validation lab testing (190).

In accordance with the present invention, FIG. 1c shows the process for the Competitive Analysis phase, comprising the steps of combining data from Research phase (210), combining data from the Validation phase (220), validating and proving the research, and performing the Competitive analysis (230).

In accordance with the present invention, FIG. 1d shows the process for the Presentation phase, comprising the steps of presenting the output in the form of (310) Presenting findings of technical marketing and competitive analysis in output, Presenting findings of technical marketing and competitive analysis in Technical Briefs, Presenting findings of technical marketing and competitive analysis in Technical Alerts, Presenting findings of technical marketing and competitive analysis in Technical Presentations, Presenting findings of technical marketing and competitive analysis in Sales Presentations, Presenting findings of technical marketing and competitive analysis in Sales Training, Presenting findings of technical marketing and competitive analysis in Sales Webinars, Presenting findings of technical marketing and competitive analysis in Training documents, Presenting findings of technical marketing and competitive analysis in Training presentations, Presenting findings of technical marketing and competitive analysis in Transfer of Information, Presenting findings of technical marketing and competitive analysis in How-to Guides, Presenting findings of technical marketing and competitive analysis in Implementation Guides, Presenting findings of technical marketing and competitive analysis in White Papers, Presenting findings of technical marketing and competitive analysis in Website Collateral, Presenting findings of technical marketing and competitive analysis in Press Releases, Presenting findings of technical marketing and competitive analysis in Presentation kits, Presenting findings of technical marketing and competitive analysis in Marketing Kits, Presenting findings of technical marketing and competitive analysis in Competitive Reports, Presenting findings of technical marketing and competitive analysis in Analyst Reports, Presenting findings of technical marketing and competitive analysis in Industry Reports, Presenting findings of technical marketing and competitive analysis in Product Datasheets, Presenting findings of technical marketing and competitive analysis in RFI, RFQ, RFP responses, Presenting findings of technical marketing and competitive analysis in RFI, RFQ, RFP boilerplates, Presenting findings of technical marketing and competitive analysis in MRD's, Presenting findings of technical marketing and competitive analysis in PRD's, Presenting findings of technical marketing and competitive analysis in Proof of Record, Presenting findings of technical marketing and competitive analysis in Roadmaps, Presenting findings of technical marketing and competitive analysis in Intellectual Property documents, Presenting findings of technical marketing and competitive analysis in Strategic planning, Presenting findings of technical marketing and competitive analysis in Product Management documents, Presenting findings of technical marketing and competitive analysis in Product Marketing documents, and Presenting findings of technical marketing and competitive analysis in Competitive Marketing documents.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for validating and proving competitive analysis from hands-on lab testing and publicly available research information comprising the steps of:
Gathering publicly available information from the internet;
Gathering publicly available information from tradeshows;
Gathering publicly available information from published financials;
Gathering Information from insiders;
Gathering Information from industry analysts;
Gathering Information from industry press;
Compiling information gathered from Research;
Preparing Lab Layout in a network diagram electronically with computer software or manually on paper or whiteboard;
Developing test methodology and test plan electronically with computer software or manually on paper or whiteboard;
Building physical test network;
Placing device under test, or device to be tested into the test network;
Performing the test;
Examing the results of testing;
Determining if results of testing are compatible with gathered Research;
Revising test methodology and test plan, and re-testing the device;
Compiling information gathered from hands-on validation lab testing;
Combining data from Research phase and Validation testing phase;
Performing technical marketing and competitive analysis on Research and Validation testing data;
Presenting findings of technical marketing and competitive analysis in output;
Presenting findings of technical marketing and competitive analysis in Technical Briefs;
Presenting findings of technical marketing and competitive analysis in Technical Alerts;
Presenting findings of technical marketing and competitive analysis in Technical Presentations;
Presenting findings of technical marketing and competitive analysis in Sales Presentations;
Presenting findings of technical marketing and competitive analysis in Sales Training;
Presenting findings of technical marketing and competitive analysis in Sales Webinars;
Presenting findings of technical marketing and competitive analysis in Training documents;
Presenting findings of technical marketing and competitive analysis in Training presentations;
Presenting findings of technical marketing and competitive analysis in Transfer of Information;
Presenting findings of technical marketing and competitive analysis in How-to Guides;
Presenting findings of technical marketing and competitive analysis in Implementation Guides;
Presenting findings of technical marketing and competitive analysis in White Papers;
Presenting findings of technical marketing and competitive analysis in Website Collateral;
Presenting findings of technical marketing and competitive analysis in Press Releases;
Presenting findings of technical marketing and competitive analysis in Presentation kits;
Presenting findings of technical marketing and competitive analysis in Marketing Kits;
Presenting findings of technical marketing and competitive analysis in Competitive Reports;
Presenting findings of technical marketing and competitive analysis in Analyst Reports;
Presenting findings of technical marketing and competitive analysis in Industry Reports;
Presenting findings of technical marketing and competitive analysis in Product Datasheets;
Presenting findings of technical marketing and competitive analysis in RFI, RFQ, RFP responses;
Presenting findings of technical marketing and competitive analysis in RFI, RFQ, RFP boilerplates;
Presenting findings of technical marketing and competitive analysis in MRD's;
Presenting findings of technical marketing and competitive analysis in PRD's;
Presenting findings of technical marketing and competitive analysis in Proof of Record;
Presenting findings of technical marketing and competitive analysis in Roadmaps;
Presenting findings of technical marketing and competitive analysis in Intellectual Property documents;
Presenting findings of technical marketing and competitive analysis in Strategic planning;
Presenting findings of technical marketing and competitive analysis in Product Management documents;
Presenting findings of technical marketing and competitive analysis in Product Marketing documents; and
Presenting findings of technical marketing and competitive analysis in Competitive Marketing documents.
